(19) United States
(12) Patent Application Publication
(10) Pub. No.: US 2018/0099500 A1
(43) Pub. Date: Apr. 12, 2018

(54) METHOD FOR ACTUATING LIQUID DISCHARGE ELEMENTS

(71) Applicant: Océ Holding B.V., Venlo (NL)

(72) Inventors: Daniël H.A. DRIESSEN, Venlo (NL); Lambertus M.L. VAN SAS, Venlo (NL); Jacques J.M. GERAETS, Venlo (NL); Jan P.J. VERSTEGEN, Venlo (NL)

(73) Assignee: Océ Holding B.V., Venlo (NL)

(21) Appl. No.: 15/724,042

(22) Filed: Oct. 3, 2017

(30) Foreign Application Priority Data
Oct. 11, 2016 (EP) 16193283.5

(51) Int. Cl. B41J 2/045

(52) U.S. Cl. CPC B41J 2/04541; B41J 2/04586

(57) ABSTRACT

A method is provided for actuating an liquid discharge element in an array of discharge elements of a print head. The liquid is provided to the elements of the array through a channel in the print head. A discharge element is provided with a driving signal from a set of signals comprising a discharging signal, a non-discharging signal, and a null signal. Only the first signal generates a drop of liquid, the second and third do not. An amount of discharging signals supplied to the print head is determined in accordance with a required number of droplets. A ratio of non-discharging signals versus null signals for the elements that do not discharge a drop of liquid increases with increasing amount of discharging signals. The elements receiving an non-discharge signal are selected randomly from the elements not discharging a drop of liquid. This extends the time that the print head may be operated without maintenance.

### BACKGROUND OF THE INVENTION

### 1. Field of the invention

The invention relates to a method for actuating ink discharge elements in an array of elements of a print head in accordance with a predetermined pattern of drops. The invention further relates to a print system.

### 2. Description of the Related Art

High volume, high speed cut-sheet and webprinters are known. Contemporary color print systems of these kinds apply colored ink, comprising any material or mixture in a liquid state, to a substrate using a print head for discharging ink drops in accordance with image data. The print head comprises an array of discharge elements, the array stretching along a width of the substrate. While the print head is fixed, the substrate is transported along an ink discharging side of the print head in a direction perpendicular to the direction of the array. When provided with appropriate signals, the print head is capable of jetting ink drops at such timings that lines of dots result on the substrate, enabling the reproduction of an image on the substrate.

The ink is supplied to the elements through an ink channel in the print head. Due to the high print speed of the print systems, an ink flow through these channels can be as high as 10 to 100 ml/min. Each of the ink discharge elements, or print elements, is provided with a nozzle to discharge ink from. Each of the elements further comprises an actuator that converts an electric signal into a mechanical displacement, thus either expanding or contracting an ink pressure chamber. If the electric signal is sufficiently large, an ink drop is created at an end of the nozzle of the print element. This ink drop discharging signal may comprise several pulse shapes at predetermined timings in order to generate a required droplet and to leave as little as possible pressure fluctuations in the ink pressure chamber, such that the ink discharge element is left ready to produce a further ink droplet. An image comprising a set of dots on predetermined positions may be reproduced on the substrate by appropriate timing of ink drop discharging signals to the array of print elements. At positions where no dot is required, no actuation of the corresponding print elements is applied, which is described in this disclosure as providing a null signal.

A known method for actuating a print element comprises, in addition to applying a discharging signal to obtain an ink drop and to applying a null signal to refrain from an ink drop, a non-discharging signal that causes a pressure wave in the ink pressure chamber of an element without generating a drop from the corresponding nozzle. This signal may comprise the same or another set of pulse shapes as a discharging signal, as long as the amplitude or the duration of the signal is sufficiently small. This non-discharging signal may be applied regularly to bring the ink in the pressure chamber and the nozzle into motion, thereby preventing clogging of ink in the nozzle. Ink clogging may result in a clogged nozzle, leading to a malfunctioning print element, thereby possibly deteriorating the printed image quality. Especially if a nozzle has not been applying an ink drop for some time, it has proven to be practical to use a non-discharging signal for actuating a print element.

This non-discharging signal is mainly applied just before a discharging signal is scheduled in order to bring the ink in a nozzle into motion, thereby improving the effectivity of a discharging signal that is not preceded by another discharging signal. Depending on the history of the application of an ink discharge element, a non-discharging signal may be used instead of no activation signal at all, both not resulting in an ink drop. A disadvantage of using non-discharging signals is that it leads to additional energy dissipation in the print head, thus possibly raising its temperature, or alternatively, necessitating supplemental cooling of the print head. It goes without saying that a non-discharging signal can only be applied if no dot is required at a corresponding position on the substrate.

A further use of a non-discharging signal is disclosed in the US patents U.S. Pat. No. 5,831,650 and U.S. Pat. No. 6,331,052 wherein this kind of signal is used to counteract a mechanical cross-talk effect of a neighboring print element that is actuated by a discharging signal. The use of a non-discharging signal may in this case facilitate the constraints to the structure of a print head.

However, during application of several activation schemes with a plurality of images, an epidemic failure of print elements in connection with a single channel in the print head occurred when a print head was used for a long print run with high ink coverage. This entails that the print elements seemed to run out of ink, starting at one of the print elements and infecting its neighboring elements until barely any of the print elements could supply a drop of ink upon request. This phenomenon was solved by starting a process of purging, wiping and flushing the print head, wherein ink is thrusted through the infected ink channel, thereby filling all the defective print elements with ink. This procedure is a well-known maintenance procedure that takes some time, since the print head is brought from a print position to a capping station that accepts the ink spoiled in the process.

A problem with the above-mentioned method of working is that the productivity, that is the number of prints that is printed per unit of time, decreases, since the procedure is applied precautionarily to avoid obtaining defective prints. A further problem is that a large amount of ink is wasted. It is therefore an object of the present invention to apply an activation scheme to the print elements that maintains a high productivity without loss of ink.

### SUMMARY OF THE INVENTION

In order to achieve this object, a method for actuating ink discharge elements in an array of elements of a print head according to the invention comprises the steps of:

a) determining an amount of discharging signals supplied to the print head in accordance with a required number of drops of liquid;

b) determining a ratio of non-discharging signals versus null signals for the elements in connection with a single channel that do not discharge a drop of liquid, which ratio increases with increasing amount of discharging signals, and

c) applying to each element of the printhead either a discharging signal, a non-discharging signal or a null signal in accordance with a predetermined pattern of drops, wherein the elements that receive a non-discharging signal are selected randomly from the elements that do not discharge a drop.

The provision of non-discharging signals, that stir the ink in the ink chamber and nozzle of a print element without leading to an ink drop leaving the print element, to the print elements that are not required to generate a drop of ink has proven to postpone or even eliminate the epidemic break down of print elements in a long run of prints with a high coverage as described earlier. It is believed that this break down is related to an underpressure that materializes in the channel providing ink to the drop generating elements. This underpressure causes a retraction of ink from the print elements that are not generating an ink drop, thus letting air creep into these elements. Once a print element is filled with a sufficient amount of air, it can no longer be supplied with ink, unless a maintenance process is started. The provision of a non-discharging signal to a print element is thought to prevent air leaking into the print element. The more elements are generating ink drops and the longer they are actuated to do this, the more the chance of air leaking into not activated elements needs to be suppressed, which is reached by an increasing ratio of non-discharging signals to null signals for randomly selected non-discharging elements. To give an example, in a situation wherein a required amount of ink is provided by supplying 80% of the ink discharge elements with a discharging signal, it is determined that a ratio of non-discharging versus null signals is 40%. This means that 8% of the ink discharge elements are supplied with a non-discharging signal and 12% of the ink discharge elements are supplied with a null signal. Obviously, the non-discharging signals do not waste ink, thus solving the above-mentioned problems of the prior art.

In a further embodiment the ratio in step b) approaches 100% if the amount of discharging signals approaches a maximum. Since there are always some print elements that are not involved in generating ink drops, e.g. at the edges of a print head, there are always elements that are susceptible to the effect of air leaking in, which is stronger the more print elements are jetting ink drops. Thus, at maximum of print elements discharging a drop of ink, it is advantageous to provide all non-discharging elements with a non-discharging signal instead of a null signal.

In a further embodiment, at least one non-discharging signal is applied if the amount of discharging signals is above 50% of all the signals provided to the print head.

Further details of the invention are given in the dependent claims. The invention may advantageously be embodied in a print system for imagewise printing dots on a substrate, the system comprising a control unit configured for executing one of the methods described above.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a print system configured to apply the invented method;

FIG. 2 is a high coverage test image;

FIG. 3 is an implementation of a method according to the invention, and

FIG. 4 is a relation between the no-dot ratio and the coverage.

### DETAILED DESCRIPTION OF EMBODIMENTS

The present invention will now be described with reference to the accompanying drawings, wherein the same or similar elements are identified with the same reference numeral.

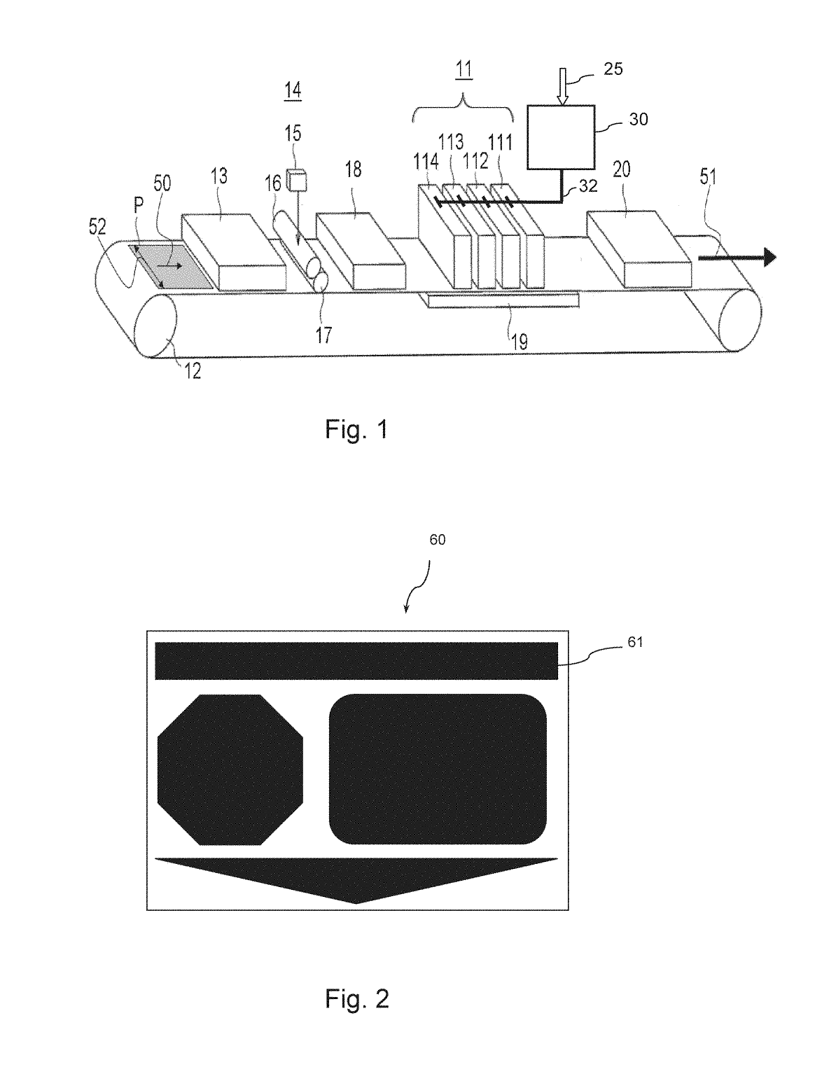

A print system in which a method according to the present invention may be suitably used is described with reference to the appended schematic drawing shown in FIG. 1.

FIG. 1 shows a sheet of a receiving medium, P, being transported in a direction for conveyance as indicated by the arrows 50 and 51 with the aid of transportation mechanism 12. Transportation mechanism 12 may be a driven belt system comprising one (as shown in FIG. 1) or more belts. Alternatively, one or more of these belts may be exchanged for one or more drums. A transportation mechanism may be suitably configured depending on the requirements (e.g. sheet registration accuracy) of the sheet transportation in each step of the printing process and may hence comprise one or more driven belts and/or one or more drums. For a proper conveyance of the sheets of receiving medium, the sheets need to be fixed to the transportation mechanism. The way of fixation is not particularly limited and may be selected from electrostatic fixation, mechanical fixation (e.g. clamping) and vacuum fixation. Of these vacuum fixation is preferred.

The printing process as described below comprises of the following steps: media pre-treatment (14), image formation (11), drying and fixing (20) and optionally post treatment (not indicated).

A media pre-treatment 14 is applied to improve the spreading and pinning (i.e. fixation of pigments and water-dispersed polymer particles) of the ink on the receiving medium P, in particular on slow absorbing media, such as machine coated media, prior to printing an image on the medium. In FIG. 1 a pre-treatment module is shown comprising a pre-heating unit 13, for example a radiation heater, a roller coating unit with two rollers 16, 17 providing an aqueous pre-treatment liquid to the coated printing paper P from storage tank 15, and a drying member 18 that reduces the quantity of the water content in the applied coating. Each surface of the double rolls 16, 17 may be covered with a porous resin material such as sponge. Alternative methods of application of a pre-treatment liquid include an ink-jet application, a curtain coating and a spray coating. A roller coating method, as in FIG. 1, is preferable because this coating method applies the pre-treatment liquid homogeneously to a recording medium. In addition, the amount of the applied pre-treatment liquid with a roller or with other means to a recording medium can be suitably adjusted by controlling the physical properties of the pre-treatment liquid, the contact pressure of a roller in a roller coater to the recording medium and the rotational speed of a roller in a roller coater which is used for a coater of the pre-treatment liquid. From the viewpoint of drying uniformity, the application of a pre-treatment liquid to the entire surface of a coated printing paper is preferable, since application to a limited portion, such as a printed portion of the medium, may lead to unevenness between an application area and a non-application area caused by swelling of cellulose contained in the coated printing paper, in particular in the case of an aqueous pre-treatment liquid. An additional pre-treatment method may be provided by a corona or plasma treatment unit, wherein a sheet of a receiving medium is exposed to a corona discharge. In particular when used on media like polyethylene (PE) films, polypropylene (PP) films, polyetyleneterephtalate (PET) films and machine coated media, the adhesion and spreading of the pre-treatment liquid and the ink is improved by increasing the surface energy of the media.

The step of image formation 11 is applied by four ink jet marking devices 111, 112, 113, and 114, positioned above the belt transporting the receiving medium P. Each device is as wide as the width 52 of the medium, thus making lateral movements of the devices unnecessary. The devices are provided with ink in the colors cyan, magenta, yellow and black to produce a full color print using a CMYK subtractive color mixing scheme. The digital signals, or print signals, to control the individual liquid discharge elements of the marking devices are composed by the control module 30 from image data 25 using a high speed connection 32. An ink jet marking device as indicated above is also known as a page wide array and comprises a number of print heads wherein the discharge elements are also referred to as print elements, or nozzles, a nozzle being the part of a print element where the ink drops originate. Ink is supplied to the individual print elements through a channel in a print head. Not shown is a maintenance position wherein the marking devices are brought for flushing, purging and wiping the devices.

Each of the inkjet marking devices 111, 112, 113, 114 has a length of at least the width 52 of the desired printing range. The inkjet marking device may comprise a single print head or may be constructed by combining two or more print heads, such that the combined lengths of the individual heads cover the entire width of the printing range. Such a constructed inkjet marking device is also termed a page wide array (PWA) of print heads. The print heads may have a staggered arrangement to provide a PWA with nozzles which are substantially equidistant in the length direction of the inkjet marking device. The staggered configuration may provide a redundancy of nozzles in an area where the inkjet heads of a first row and a second row overlap. Staggering may also be used to decrease a nozzle pitch, thereby increasing the print resolution, in the length direction of the inkjet marking device. The resolution may be further increased by using more rows of print heads, each of which are arranged such that the positions of the nozzles of each row are shifted in the length direction with respect to the positions of the nozzles of other rows.

Optionally, the image formation may be carried out while the receiving medium P is temperature controlled. For this purpose a temperature control device 19 may be arranged to control the temperature of the surface of the transportation mechanism underneath the inkjet marking module 11. The temperature control device 19 may be used to control the surface temperature of the receiving medium P, for example in a range of 30° C. to 60° C. The temperature control device 19 may comprise heaters, such as radiation heaters, and a cooling means, for example a cold blast, in order to control the surface temperature of the receiving medium within said range. Subsequently and while printing, the receiving medium P is conveyed to the down stream part of the inkjet marking module 11.

After an image has been formed on the receiving medium, the prints are dried and the image is fixed onto the receiving medium. Drying comprises the evaporation of solvents, in particular those solvents that have poor absorption characteristics with respect to the selected receiving medium.

FIG. 1 schematically shows a drying and fixing unit 20, which may comprise a heater, for example a radiation heater. After an image has been formed, the print is conveyed to and passed through the drying and fixing unit 20. The print is heated such that solvents, in the present embodiment to a large extent water, in the printed image evaporate. The speed of evaporation and hence drying may be enhanced by increasing the air refresh rate in the drying and fixing unit 20. Simultaneously, film formation of the ink occurs, because the prints are heated to a temperature above the minimum film formation temperature. The residence time of the print in the drying and fixing unit 20 and the temperature at which the drying and fixing unit 20 operates are optimized, such that when the print leaves the drying and fixing unit 20 a dry and robust print has been obtained. As described above, the transportation mechanism 12 in the fixing and drying unit 20 may be separated from the transportation mechanism of the pre-treatment and printing section of the printing apparatus and may comprise a belt or a drum.

FIG. 2 shows a test image 60 for a high coverage, long run test. The black parts, such as 61, of the test image indicate where any of the available inks is to be applied. The coverage of the image is about 80%. Some print elements at the side of the image are not applied at all. These are the ones most susceptible to be the origin of an epidemic failure in a long run, e.g. more than 100 prints in a row, directly after one another. By activating these elements with a non-discharging signal, that stirs the ink in the element without discharging a drop of ink, instead of a null signal, that leaves the element unactivated, this failure effect is suppressed.

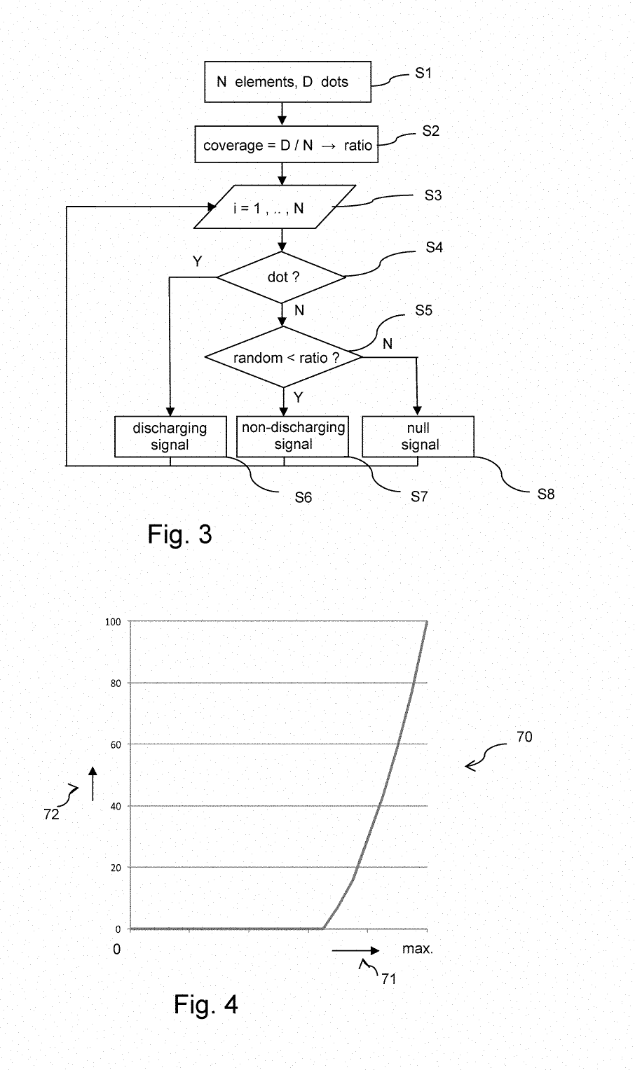

FIG. 3 shows an embodiment of the individual steps of the invention. These steps are carried out in control module 30 when converting image data to print signals. In a first step, S1, the number of elements of a PWA is determined. Note that it is not necessary to know the exact configuration of the PWA, only a number N of elements that are to be controlled is to be determined. This may include elements that are used several times for a specified image area. Furthermore the number D of dots that are required in this area is to be determined. The number of dots corresponds to the number of print elements that is activated with a discharging signal, i.e. a print signal that makes the print element discharge a drop of ink. In a next step, S2, a coverage is determined by dividing D by N. The coverage, being a number in the range from 0 to 1, yields a ratio of according to a predetermined relation between the two quantities, as will be elucidated in FIG. 4. In step S3 a loop is started for each print element in the set. First, it is checked in step S4 if the element is associated with a dot. If yes (Y), a discharging signal is attributed to the print element in step S6 and the loop proceeds to the next element. If no (N), in step S5 a random number between 0 and 1 is selected and compared to the ratio of step S2: if the random number is smaller than the ratio, branch Y, a non-discharging signal is attributed to the print element in step S7. If it is not, branch N, a null signal is attributed in step S8. Thus all print elements receive one of the three indicated print signals. Note that when the ratio is large, it will often happen that a random number is smaller than the ratio, thereby increasing the number of non-discharging signals relative to the number of null signals. According to the invention, this is correlated to a situation of high coverage.

Therefore, as shown in FIG. 4, the relation 70 between the coverage and the ratio, as used in step S2 in FIG. 3, relates a high coverage, indicated on the horizontal axis 71, to a high ratio, indicated on the vertical axis 72. For low values of the coverage, lower than 0.6, or 60%, a ratio of 0 is selected. This means that no non-discharging signals will be used. For high values of the coverage, up to a maximum, usually 1, or 100%, a high ratio is selected, up to 1, or 100%. Thus, a number of non-discharging signals remains restricted, keeping an associated heating effect limited, and at the same time, a number of non-discharging signals is applied to diminish a risk of air leaking into non-used print elements.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method for actuating liquid discharge elements in an array of discharge elements of a print head in accordance with a predetermined pattern of drops, a liquid being provided to the elements of the array through a channel in the print head, each discharge element being provided with a driving signal from a set of signals comprising a discharging signal, that, when applied to a discharge element, stirs the liquid in the element for discharging a drop of liquid, a non-discharging signal, that, when applied to a discharge element, stirs the liquid in the element without discharging a drop of liquid and a null signal, that, when applied to a discharge element, does not stir the liquid in the element and does not discharge a drop of liquid, the method comprising the steps of:
a) determining an amount of discharging signals supplied to the print head in accordance with a required number of drops of liquid;
b) determining a ratio of non-discharging signals versus null signals for the elements in connection with a single channel that do not discharge a drop of liquid, which ratio increases with increasing amount of discharging signals, and
c) applying to each element of the print head either a discharging signal, a non-discharging signal or a null signal in accordance with said predetermined pattern of drops,
wherein the elements that receive a non-discharging signal are selected randomly from the elements that do not discharge a drop.

2. The method according to claim 1, wherein the ratio in step b) approaches 100% if the amount of discharging signals approaches a maximum.

3. The method according to claim 1, wherein a non-discharging signal is applied if the amount of discharging signals is above 50% of all the signals provided to the print head.

4. A print system for imagewise printing dots on a substrate, the system comprising a control unit configured for executing a method according to claim 1.

5. A print system according to claim 4, wherein the print head is a page-wide print head that remains stationary during a print process.
